(19) United States
(12) Patent Application Publication
(10) Pub. No.: US 2002/0120509 A1
(43) Pub. Date: Aug. 29, 2002

(54) Prize advertisement service system and method of conducting prize advertisement

(75) Inventor: Yoichi Okano, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/046,782

(22) Filed: Jan. 17, 2002

(30) Foreign Application Priority Data
Jan. 18, 2001 (JP) 2001-9738

(51) Int. Cl. G06F 17/60

(52) U.S. Cl. 705/14

(57) ABSTRACT

A prize advertisement service system includes a first terminal of a prize advertisement presenter who presents a prize advertisement, a second terminal of a user who applies for the prize advertisement, and a server of a service provider which connects the first and second terminals to each other through a communication network. The server includes functions of registering prize advertisements into the server, registering a user who wants to apply for the prize advertisements, selecting a prize advertisement(s) which matches to the user, among the registered prize advertisements, transmitting data indicative of a list of the selected prize advertisement(s), to the second terminal, receiving an application of the user for one or more prize advertisements among the listed prize advertisement(s), from the second terminal, and transmitting the user information of the user having applied for the prize advertisements, to the first terminal as applicant data indicative of an applicant or applicants applying for the prize advertisement(s).

### BACKGROUND OF THE INVENTION

1. Field of the Invention

The invention relates to a prize advertisement service system and a method of conducting a prize advertisement, and more particularly to such a system and a method both of which are capable of conducting a desired advertisement by conducting a prize advertisement on a communication network, and collecting data about applicants who apply for the prize advertisement.

2. Description of the Related Art

With the extension of a communication network such as Internet, services for distributing various informations through a communication network attract attention as advertising means. In addition, such services attract attention, further since they can readily collect data of a lot of users due to interactivity of a communication network.

For the above-mentioned reasons, prize advertisement services are provided for conducting a prize advertisement on a communication network to thereby conduct a desired advertisement and collect users' data.

For instance, Japanese Unexamined Patent Publication No. 2000-101635 has suggested a prize advertisement system wherein information about prize advertisements presented by a plurality of prize advertisement presenters is distributed to a plurality of users, and information of users who applied for the prize advertisements is provided to the prize advertisement presenters.

Japanese Unexamined Patent Publication No. 11-3372 has suggested a system wherein if a user makes access to a homepage presented by an administrator, through a communication network such as Internet, and inputs his/her data to the homepage, his/her data is stored in a database of the administrator, and an ID number or a password is assigned to the user. Thereafter, each time the user makes access the homepage, the user obtains a coupon point. Such a coupon point is automatically stored in the database. The administrator manages a total of the coupon points for each of users, and presents an incentive such as a prize or a discount to each of the users in accordance with his/her coupon points.

Japanese Unexamined Patent Publication No. 2000-293591 has suggested a prize competition system including a first server owned by a prize presenter, a second server owned by a user who applies for the prize competition presented by the prize presenter, a third server connecting the first and second servers to each other, and a network through which the first to third servers connect to one another. The first server includes means for providing a user making access thereto with information about a prize competition. The third server includes means for providing the applicant user with information containing an address of the first server, means for showing a question associated with the prize presenter, to the applicant user, and facilitating the applicant user to answer the question, and means for guiding the applicant user to input data necessary for applying for the prize competition, when the answer has a correction ratio equal to or greater than a predetermined ratio.

In a prize advertisement system such as the above-mentioned ones, it is possible for an applicant to reduce or omit data necessary for applying for a prize advertisement, making use of users' data having been stored so far.

Some of prize advertisement systems are designed to include a web page for informing a plurality of users of prize advertisement information. The users can know prize advertisements by making access to the web page.

As an alternative, some of prize advertisement systems are designed to have a mail-magazine system by which prize advertisement information is distributed to each of users through an e-mail, or have a mailing-list. E-mails can be concurrently transmitted to users listed in the mailing-list.

However, the above-mentioned conventional prize advertisement service systems are accompanied with problems as follows.

The first problem is that it is not possible for a prize advertisement presenter to have effective advertising effects to target users. Herein, target users mean users to which a prize advertisement presenter desires to present a prize advertisement, and which may be grouped in accordance with gender, age, job, address or hobby and the like. The reason of the first problem being caused is that non-target users as well as target users apply for a prize advertisement, because they are interested in a prize presented in the prize advertisement better than in an advertisement.

The second problem is that it is difficult for a user to apply for a plurality of prize advertisements. This is because prize advertisement information about individual prize advertisements is provided to a user individually through an e-mail.

The above-mentioned web-page inherently contains the first problem, because it informs a plurality of users of a plurality of prize advertisements at a time.

### SUMMARY OF THE INVENTION

In view of the above-mentioned problems in the conventional prize advertisement service systems, it is an object of the present invention to provide a prize advertisement service system and a method of conducting a prize advertisement both of which are capable of effectively advertising to desired target users, and both of which further allow a user to readily apply for a plurality of prize advertisement.

In one aspect of the present invention, there is provided a prize advertisement service system where a desired advertisement is conducted by conducting a prize advertisement is conducted on a communication network, and data about applicants who apply for the prize advertisement is collected, including (a) a first terminal of a prize advertisement presenter who presents a prize advertisement, (b) a second terminal of a user who applies for the prize advertisement, and (c) a server of a service provider which connects the first and second terminals to each other through a communication network, the server including functions of (c1) registering prize advertisements into the server in accordance with prize advertisement information received from the first terminal, (c2) registering a user who wants to apply for the prize advertisements, in accordance with user information received from the second terminal, (c3) selecting one or more prize advertisement(s) which matches to the user, among the registered prize advertisements, in accordance with the user information, (c4) transmitting data indicative of a list of the selected prize advertisement(s), to the second terminal, (c5) receiving an application of the user for one or more prize advertisements among the listed prize advertisement(s), from the second terminal, and (c6) transmitting the user information of the user having applied for the prize advertisements, to the first terminal as applicant data indicative of an applicant or applicants applying for the prize advertisement(s).

It is preferable that the server determines the number of prize advertisements listed in the list, in accordance with an application frequency predetermined in the user information, when the server selects the one or more prize advertisement(s).

It is preferable that the server further has a function of administrating the number of applications of a user for the prize advertisement(s) listed in the list, and deciding presenting a special award to a user who applied for the prize advertisement(s) by the predetermined number.

It is preferable that the first terminal has a function of selecting one or more applicant(s) among the applicants identified by the applicant data transmitted from the server, for presenting a prize identified in the prize advertisement(s) thereto, by drawing lots.

It is preferable that the first terminal further has a function of managing delivery of a prize presented in the prize advertisement(s), to the selected user(s), based on the result of the lots.

It is preferable that the server further has a function of drawing lots for selecting one or more user(s) among the users to which the special award was presented.

It is preferable that the server further has a function of managing delivery of a prize to the selected user(s), based on the result of the lots.

It is preferable that the server further has functions of selecting one or more applicant(s) among the applicants of the prize advertisement(s), for presenting a prize identified in the prize advertisement(s) thereto, by drawing lots, and transmitting data indicative of the selected applicant(s) to the first terminal as prize-winner data.

It is preferable that the first terminal has a function of managing delivery of a prize to the selected applicant(s), based on the prize-winner data transmitted from the server.

It is preferable that the prize transmitted from the first terminal to the second terminal of the selected applicant(s) is comprised of electronic data.

It is preferable that the prize transmitted from the server to the second terminal of the selected applicant(s) is comprised of electronic data.

It is preferable that the prize transmitted from the first terminal to the second terminal of the selected applicant(s) is comprised of electronic data.

It is preferable that the second terminal is comprised of a cellular phone.

In another aspect of the present invention, there is provided a method of conducting a prize advertisement in a prize advertisement service system for conducting a desired advertisement and collecting data about applicants who apply for the prize advertisement, the prize advertisement service system including a first terminal of a prize advertisement presenter who presents a prize advertisement, a second terminal of a user who applies for the prize advertisement, and a server of a service provider which connects the first and second terminals to each other through a communication network, the method including the steps of (a) registering prize advertisements into the server in accordance with prize advertisement information received from the first terminal, (b) registering a user who wants to apply for the prize advertisements, in accordance with user information received from the second terminal, (c) selecting one or more prize advertisement(s) which matches to the user, among the registered prize advertisements, in accordance with the user information, (d) transmitting data indicative of a list of the selected prize advertisement(s), to the second terminal, (e) receiving an application of the user for one or more prize advertisements among the listed prize advertisement(s), from the second terminal, and (f) transmitting the user information of the user having applied for the prize advertisements, to the first terminal as applicant data indicative of an applicant or applicants applying for the prize advertisement(s), the steps (a) to (f) being to be carried out by the server.

The method may further include the step of (g) determining the number of prize advertisements listed in the list, in accordance with an application frequency predetermined in the user information, in the step (c), the step (g) being to be carried out by the server.

The method may further include the step of (h) administrating the number of applications of a user for the prize advertisement(s) listed in the list, and deciding presenting a special award to a user who applied for the prize advertisement(s) by the predetermined number, the step (h) being to be carried out by the server.

The method may further include the step of (i) selecting one or more applicant(s) among the applicants identified by the applicant data transmitted from the server, for presenting a prize identified in the prize advertisement(s) thereto, by drawing lots, the step (i) being to be carried out by the first terminal.

The method may further include the step of (j) managing delivery of a prize presented in the prize advertisement(s), to the selected user(s), based on the result of the lots, the step (j) being to be carried out by the first terminal.

The method may further include the step of (k) drawing lots for selecting one or more user(s) among the users to which the special award was presented, the step (k) being to be carried out by the server.

The method may further include the step of (l) managing delivery of a prize to the selected user(s), based on the result of the lots, the step (l) being to be carried out by the server.

The method may further include the steps of (m) selecting one or more applicant(s) among the applicants of the prize advertisement(s), for presenting a prize identified in the prize advertisement(s) thereto, by drawing lots, and (n) transmitting data indicative of the selected applicant(s) to the first terminal as prize-winner data, the steps (m) and (n) being to be carried out by the server.

The method may further include the step of (o) managing delivery of a prize to the selected applicant(s), based on the prize-winner data transmitted from the server, the step (o) being to be carried out by the first terminal.

It is preferable that the first terminal transmits electronic data to the second terminal of the selected applicant(s) as the prize in the step (o).

It is preferable that the server transmits electronic data to the selected user(s) as the prize in the step (l).

It is preferable that the first terminal transmits electronic data to the second terminal of the selected applicant(s) as the prize in the step (o).

In still another aspect of the present invention, there is provided a server to be used in a prize advertisement service system where a desired advertisement is conducted by conducting a prize advertisement is conducted on a communication network, and data about applicants who apply for the prize advertisement is collected, the server being owned by a service provider, and constituting the prize advertisement service system together with (a) a first terminal of a prize advertisement presenter who presents a prize advertisement, and (b) a second terminal of a user who applies for the prize advertisement, the server connecting the first and second terminals to each other through a communication network, the server including functions of (c1) registering prize advertisements into the server in accordance with prize advertisement information received from the first terminal, (c2) registering a user who wants to apply for the prize advertisements, in accordance with user information received from the second terminal, (c3) selecting one or more prize advertisement(s) which matches to the user, among the registered prize advertisements, in accordance with the user information, (c4) transmitting data indicative of a list of the selected prize advertisement(s), to the second terminal, (c5) receiving an application of the user for one or more prize advertisements among the listed prize advertisement(s), from the second terminal, and (c6) transmitting the user information of the user having applied for the prize advertisements, to the first terminal as applicant data indicative of an applicant or applicants applying for the prize advertisement(s).

The server may further include a function of determining the number of prize advertisements listed in the list, in accordance with an application frequency predetermined in the user information, when the server selects the one or more prize advertisement(s).

The server may further include functions of administrating the number of applications of a user for the prize advertisement(s) listed in the list, and deciding presenting a special award to a user who applied for the prize advertisement(s) by the predetermined number.

The server may further include a function of drawing lots for selecting one or more user(s) among the users to which the special award was presented.

The server may further include a function of managing delivery of a prize to the selected user(s), based on the result of the lots.

The server may further include functions of selecting one or more applicant(s) among the applicants of the prize advertisement(s), for presenting a prize identified in the prize advertisement(s) thereto, by drawing lots, and transmitting data indicative of the selected applicant(s) to the first terminal as prize-winner data.

It is preferable that the prize transmitted from the server to the second terminal of the selected applicant(s) is comprised of electronic data.

The advantages obtained by the aforementioned present invention will be described hereinbelow.

In the prize advertisement service system in accordance with the present invention, the first terminal of a prize advertisement presenter who presents a prize advertisement and the second terminal of a user who applies for the prize advertisement are connected to each other through the server of a service provider through a communication network. The server registers prize advertisements thereinto, and further registers a user who wants to apply for the prize advertisements, selects one or more prize advertisement(s) which matches to the user, among the registered prize advertisements, in accordance with the user information, transmits a list of the selected prize advertisement(s) to the second terminal, receives an application of the user for one or more prize advertisements among the listed prize advertisement(s), and transmits the user information of the user having applied for the prize advertisements, to the first terminal as applicant data indicative of an applicant or applicants applying for the prize advertisement(s).

Thus, it is possible for the prize advertisement presenter to effectively conduct an advertisement to desired target users. In addition, since a user can readily apply for a plurality of prize advertisements, it is possible to facilitate a user to apply for prize advertisements. Furthermore, since information about users having applied for a prize advertisement is transmitted to the server as applicant information, it would be possible to reduce workload of a user for applying for a prize advertisement, facilitating a user to apply for prize advertisements much more.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a block diagram of the prize advertisement service system in accordance with a preferred embodiment of the present invention.

FIG. 2 illustrates an example of a display image for registering a user through the second terminal comprised of a cellular phone.

FIG. 3 is a sequence chart of the prize advertisement service system illustrated in FIG. 1.

FIG. 4 is a block diagram of the prize advertisement service system carrying out registration of prize advertisement information.

FIG. 5 illustrates an example of a display image for registering a user through the second terminal comprised of a cellular phone.

FIG. 6 is a block diagram of the prize advertisement service system carrying out registration of a user.

FIG. 7 illustrates an example of a prize advertisement list displayed on a screen of the second terminal comprised of a cellular phone.

FIG. 8 is a block diagram of the prize advertisement service system carrying out delivery of a prize to a user from a prize advertisement presenter through a mail/courier network.

FIG. 9 is a block diagram of the prize advertisement service system carrying out delivery of a prize to a user from a service presenter through a mail/courier network.

FIG. 10 is a sequence chart of the prize advertisement service system in accordance with the second embodiment.

FIG. 11 is a block diagram of the prize advertisement service system carrying out delivery of a prize to a user from a prize advertisement presenter through a communication network.

FIG. 12 is a block diagram of the prize advertisement service system carrying out delivery of a prize to a user from a service presenter through a communication network.

FIG. 13 is a sequence chart of the prize advertisement service system in accordance with the third embodiment.

### DESCRIPTION OF THE PREFERRED EMBODIMENTS

Preferred embodiments in accordance with the present invention will be explained hereinbelow with reference to drawings.

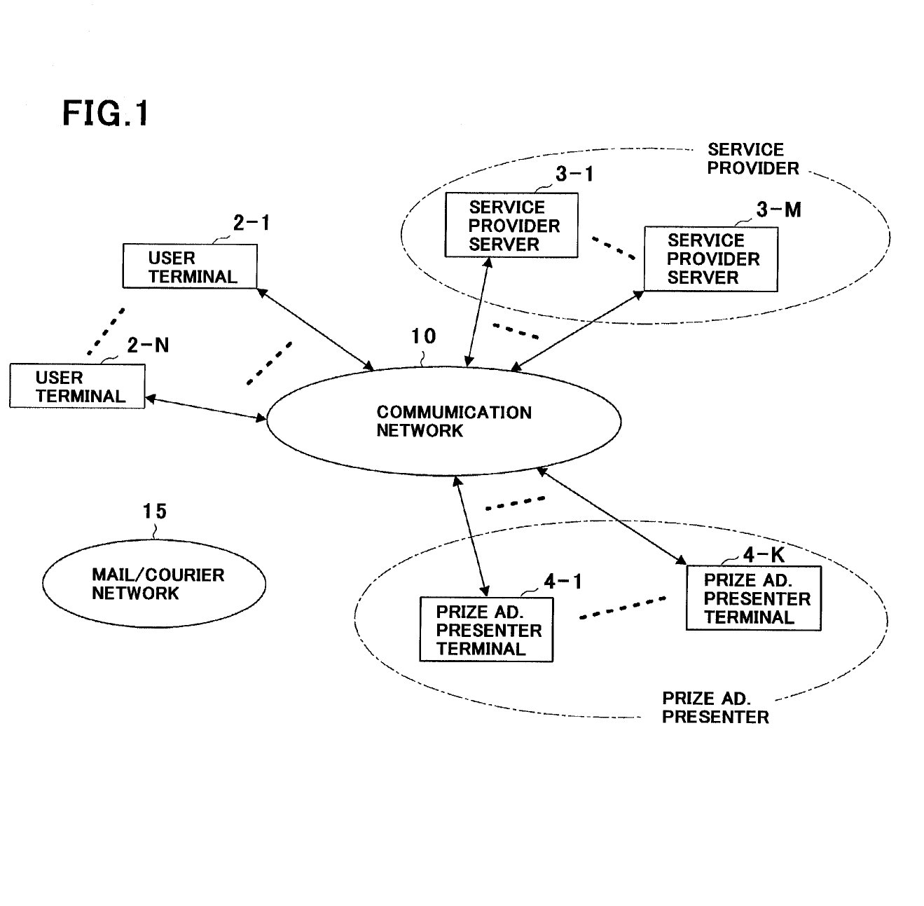

FIG. 1 is a block diagram of a prize advertisement service system in accordance with a preferred embodiment of the present invention.

The prize advertisement service system is comprised of user terminals 2-1 to 2-N, service provider servers 3-1 to 3-M, prize advertisement presenter terminals 4-1 to 4-K, a communication network 10 through which the user terminals 2-1 to 2-N, the service provider servers 3-1 to 3-M, and the prize advertisement presenter terminals 4-1 to 4-K are connected to one another, and a mail/courier network 15 which delivers a prize to a user from either a service provider or a prize advertisement presenter.

The number of the user terminals, the service provider servers and the prize advertisement presenter terminals are not to be limited to N, M and K, respectively. The prize advertisement service system may be designed to include at least one user terminal, service provider terminal, and prize advertisement presenter terminal.

In the present invention, a prize advertisement means a system wherein a prize advertisement presenter conducts an advertisement for presenting a prize such as goods, a right for monitoring a product or service, or cash, and an applicant or a user informs his/her data of the prize advertisement presenter when he/she applies for the prize advertisement. User's data includes his/her name, date of birth, age, gender, address, vocation, telephone number, mail address, indication as to whether his/her terminal is a personal computer or a cellular phone, frequency of application for prize advertisements, and hobby. On the condition that the applicant makes an answer to a quiz or a questionnaire, the prize advertisement presenter draws lots for selecting one or more applicants to whom a prize such as the above-mentioned ones is presented. The prize advertisement presenter may select all applicants to which a prize is presented.

Each of the user terminals 2-1 to 2-N is comprised of a personal computer, a cellular phone, or a personal digital assistant (PDA) all of which can connect to the communication network 10. In the embodiment, each of the user terminals 2-1 to 2-N is comprised of a cellular phone.

Each of the user terminals 2-1 to 2-N is designed to have functions of displaying prize advertisement information transmitted from each of the service provider servers 3-1 to 3-M through the communication network 10, on a screen, and inputting thereinto information necessary for registering a user or for applying a prize advertisement.

Each of the service provider servers 3-1 to 3-M is designed to have functions of receiving data from the prize advertisement presenter terminals 4-1 to 4-K and user data input into the user terminals 2-1 to 2-N by a user, making a list of prize advertisements for a user to take part in a prize advertisement application stamp rally, and transmitting the list to the user terminals 2-1 to 2-N through an e-mail or web access.

Each of the service provider servers 3-1 to 3-M is designed to further have a function of connecting to the prize advertisement presenter terminals 4-1 to 4-K through the network 10, and receiving prize advertisement information from prize advertisement presenters.

Each of the prize advertisement presenter terminals 4-1 to 4-K is comprised of a personal computer, a cellular phone or a personal digital assistant (PDA) all of which can connect and transmit prize advertisement information to each of the service provider servers 3-1 to 3-M through the communication network 10.

Each of the prize advertisement presenter terminals 4-1 to 4-K is designed to have a function of receiving applicant data transmitted from each of the service provider servers 3-1 to 3-M. When an applicant or applicants applies or apply for a prize advertisement, each of the prize advertisement presenter terminals 4-1 to 4-K receives applicant data from each of the service provider servers 3-1 to 3-M at any time or at the expiration of a prize advertisement period.

Each of the service provider servers 3-1 to 3-M receives prize advertisement information from the prize advertisement presenter terminals 4-1 to 4-K through the communication network 10, and registers prize advertisements identified by the received prize advertisement information. The prize advertisement information contains target user information for defining target users, as well as a prize competition and an advertisement. The target user information includes age, gender, address, vocation, and hobby of users and so on.

The service providers may or may not charge the prize advertisement presenters for registration of prize advertisements.

On receipt of user information from the user terminals 2-1 to 2-N through the communication network 10, each of the service provider servers 3-1 to 3-M registers a user identified with the received user information. A prize advertisement list is transmitted to the thus registered user, as mentioned later.

In order to register a user into each of the service provider servers 3-1 to 3-M, a user transmits a request of registration to the service provider servers 3-1 to 3-M through his/her user terminal.

When a user is registered in any one or more of the service provider servers 3-1 to 3-M, the user transmits user information necessary for registration, such as his/her name, date of birth or age, gender, address, vocation, telephone number, mail address, frequency of application for prize advertisements and/or hobby, as well as the request of registration.

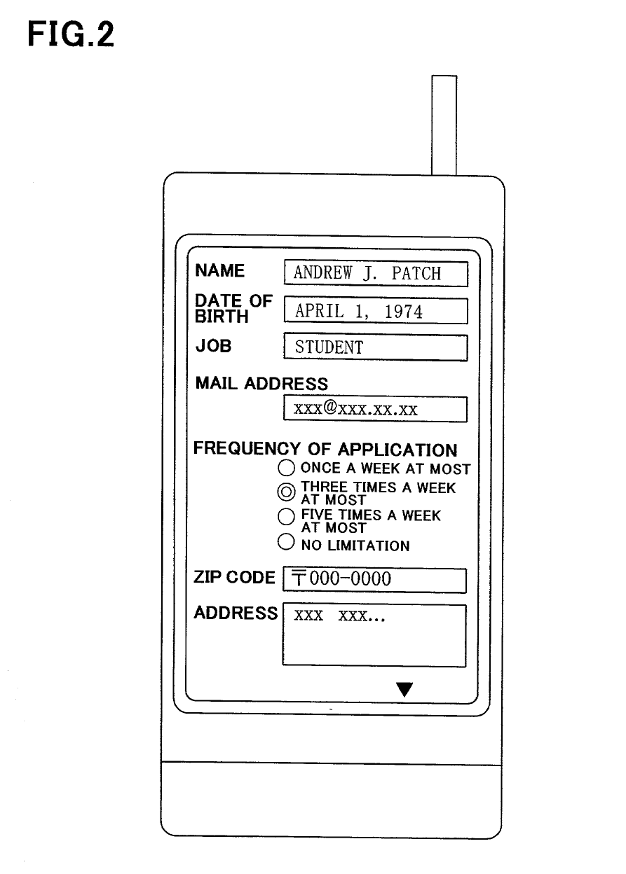

FIG. 2 illustrates an example of a registration form used in the case of each of the user terminals 2-1 to 2-N is comprised of a handy cellular phone which can connect to the communication network 10 such as Internet or Intranet.

A user may register himself/herself to each of the service provider servers 3-1 to 3-M at any or no expenses.

A user can acquire prize advertisement information registered in each of the service provider servers 3-1 to 3-M, and apply for any one or more of prize advertisements by making access to a web page of the service provider servers 3-1 to 3-M from the user terminals 2-1 to 2-N through the communication network 10, or by receiving an e-mail transmitted from the service provider servers 3-1 to 3-M through the communication network 10.

Each of the service provider servers 3-1 to 3-M selects one or a plurality of prize advertisement(s) which make a prize advertisement application stamp rally, based on user information having been stored therein.

Then, each of the service provider servers 3-1 to 3-M transmits a list of the selected prize advertisement(s) to the user terminals 2-1 to 2-N through an e-mail or web access.

Herein, a prize advertisement application stamp rally means a process carried out by a user to select any one or more of prize advertisement(s) among the prize advertisement(s) listed, and apply for the selected prize advertisement(s).

The prize advertisement list used in the prize advertisement application stamp rally lists a prize advertisement or prize advertisements which matches to information about target users, based on user information including user's name, date and birth, age, gender, address, job, telephone number, mail address and/or hobby. As an alternative, the number of prize advertisements to be listed in the prize advertisement list may be determined, based on a frequency of application for prize advertisements, which was decided by a user in his/her user information.

Thus, each of the prize advertisements registered by the prize advertisement presenters is surely provided to target users associated with the prize advertisement, and in addition, a plurality of prize advertisement can be presented to a user at a time by means of the prize advertisement list.

Then, a user selects one or more prize advertisement(s) among the listed prize advertisements, and applies for the selected prize advertisement(s) through the communication network 10. Application of the user for the prize advertisement(s) is received in each of the service provide servers 3-1 to 3-M.

Then, user information of users applying for the prize advertisements and information collected in relation to the prize advertisements are provided to each of the prize advertisement presenter terminals 4-1 to 4-K from the service provider servers 3-1 to 3-M through the communication network 10.

Each of the prize advertisement presenters and each of the service providers select one or more applicants by drawing lots in each of the prize advertisements, and transmit a prize to the selected applicant(s).

Each of the service provider servers 3-1 to 3-M always grasps development in a prize advertisement application stamp rally in each of users, that is, how many prize advertisements are applied for by each of users among the prize advertisements listed in the prize advertisement list. Each of the service provider servers 3-1 to 3-M may facilitate users to apply for prize advertisements by presenting a prize or a privilege to users. For instance, a prize may include immaterial things such as data defining original wall-paper or data defining melody which is to be played when a cellular phone receives a call, and a privilege may include a right to apply for a higher grade prize.

By introducing a prize advertisement application stamp rally such as the above-mentioned one, users would have an enhanced interest to prize advertisements, and would apply for a plurality of prize advertisements with an object of acquiring a prize or a privilege.

The service providers may charge the prize advertisement presenters for registration of prize advertisements and maintenance of registration.

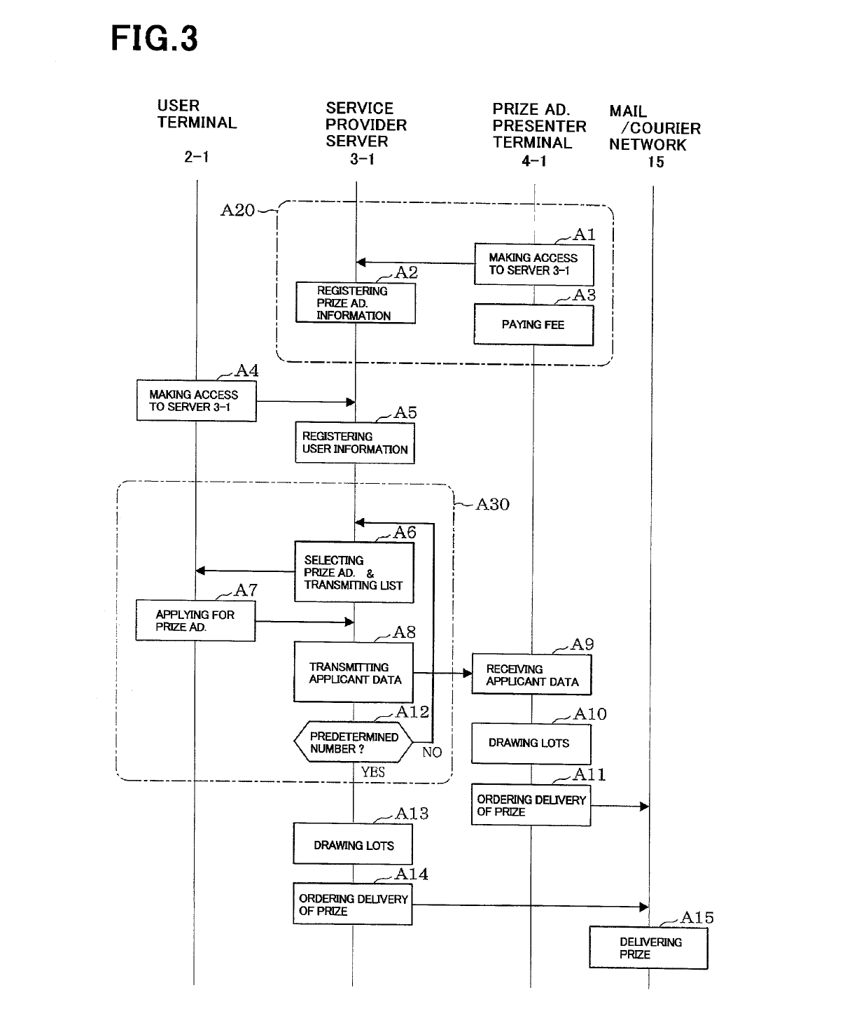

FIG. 3 is a sequence chart showing an operation of the prize advertisement service system in accordance with the embodiment. Hereinbelow is explained the operation of the prize advertisement service system.

It is assumed that the communication network 10 is comprised of Internet, the user terminals 2-1 to 2-N are comprised of a cellular phone having a function of connecting to the communication network 10, and the prize advertisement presenter terminals 4-1 to 4-K are comprised of a personal computer.

With reference to FIG. 3, a prize advertisement presenter makes access to the service provider server 3-1 from his/her prize advertisement presenter terminal 4-1 through the communication network 10, in step A1. For instance, a prize advertisement presenter may make access to the service provider server 3-1 through an e-mail or by accessing to a web page of the service provider server 3-1.

On receipt of prize advertisement information from the prize advertisement presenter terminal 4-1, the service provider server 3-1 registers a prize advertisement or prize advertisements identified with the received information, into a database, in step A2. Data about target users which the prize advertisement presenter wishes to apply for the prize advertisement(s) are also registered together with the prize advertisement information.

The prize advertisement presenter pays a fee for registration of the prize advertisement(s) in the service provider server 3-1, to a service provider, in step A3. The prize advertisement presenter may pay a fee by electronic money, for instance.

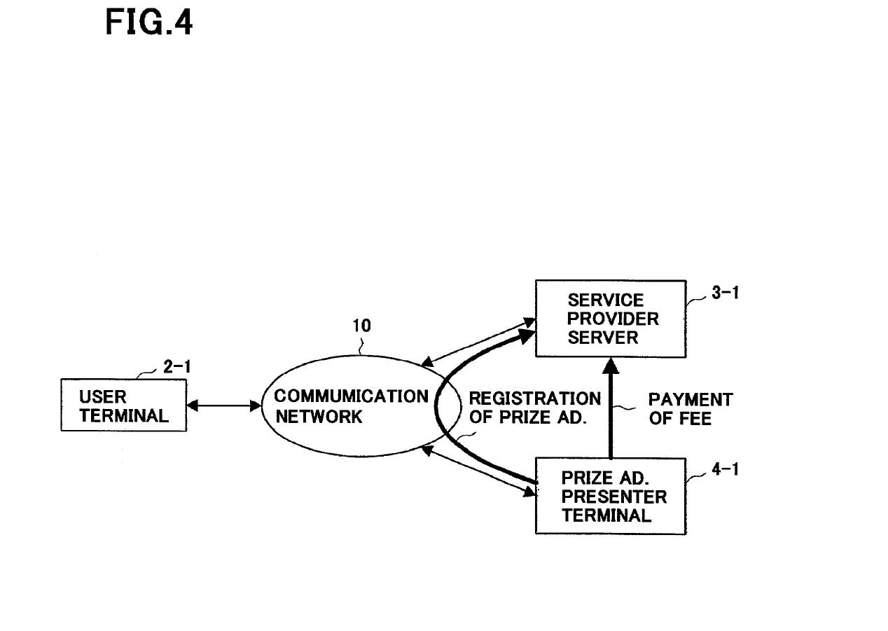

The above-mentioned steps A1 to A3 are repeatedly carried out in each of the prize advertisement presenter terminals 4-1 to 4-K, in step A20, as illustrated in FIG. 4.

When a user wants the service provider to provide him/her with prize advertisement information, a user makes access to the service provider server 3-1 from his/her user terminal 2-1 through the communication network 10, and makes registration in the service provider server 3-1. For instance, a user may make access to the service provider server 3-1 through an e-mail or by accessing to a web page of the service provider server 3-1.

The service provider server 3-1 receives user information from the user terminal 2-1, when the user makes registration, and registers the thus received user information into a database, in step A5. The user information contains, for instance, the user's name, date of birth, age, gender, address, vocation, telephone number, mail address, hobby and so on.

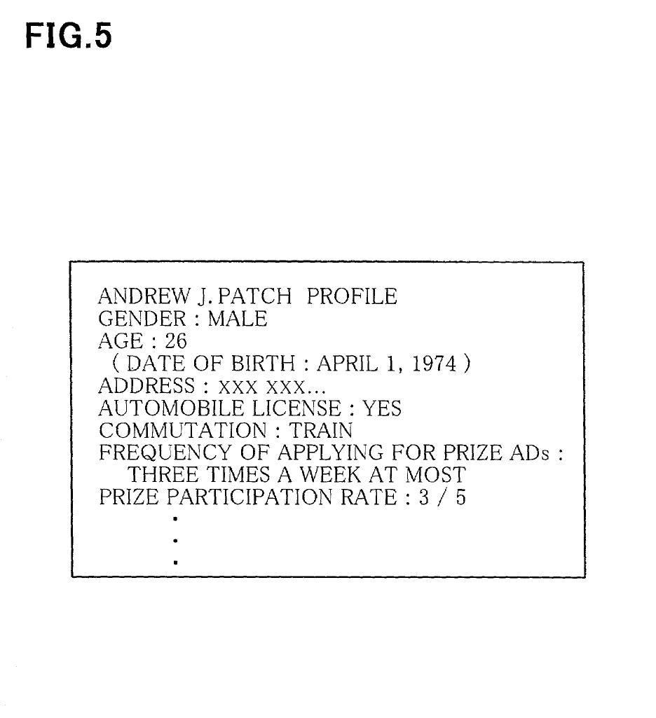

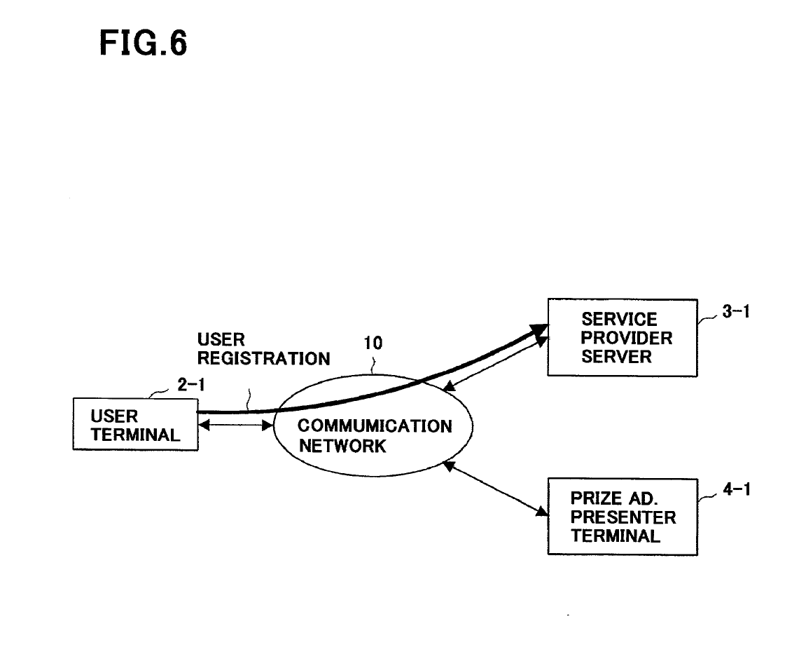

FIG. 5 illustrates an example of the user information. A user registers the user information to the service provider server 3-1 through his/her user terminal 2-1, as illustrated in FIG. 6.

The service provider server 3-1 selects a plurality of prize advertisements which match to the registered user information, based on the prize advertisement information and the target user information both having been registered in step A2, and the user information having been registered in step AS.

Then, the service provider server 3-1 makes a prize advertisement list to be used by a user in a prize advertisement stamp rally, and transmits the list to the user terminal 2-1 through an e-mail or a web page, in step A6.

The service provider server 3-1 may have a mail-magazine system by which the prize advertisement information is distributed to each of users through an e-mail, or have a mailing-list. E-mails can be concurrently transmitted to users listed in the mailing-list.

When the prize advertisement list is to be transmitted to users through a web page, the service provider server 3-1 issues an ID number or a password to each of users at the registration of a user. Each of users can make access to the web page by showing the ID number or password to the service provider server 31 for authentication.

When the service provider server 3-1 selects prize advertisements which match to each of user, the service provider server 3-1 may determine the number of prize advertisements to be listed, in accordance with the application frequency designated by the user in the user information.

For instance, since the user information illustrated in FIG. 5 shows “Frequency of applying for prize advertisements: Three times a week at most”, the service provider server 3-1 makes a prize advertisement list once a week, listing three or less prize advertisements, and transmits the list to the user.

On receipt of the prize advertisement list, the user selects and applies for a prize advertisement or prize advertisements among the listed prize advertisements. Specifically, the user makes access to the service provider server 3-1 from his/her user terminal 2-1 through the communication network 10, and transmits requisite data such as an answer to a quiz or a questionnaire, as well as the above-mentioned user information, to the service provider server 3-1.

If a user registers the user information to the service provider server 3-1 by making access to the web page of the service provider server 3-1, the user can makes access also to the prize advertisement information stored in the service provider server 3-1, based on the prize advertisement list displayed in the web page.

If the prize advertisement list is transmitted to a user through an email, the user can make access to the prize advertisement information stored in the service provider server 3-1 by virtue of a function of reading a mail written in HTML (Hyper Text Mark-up Language), or a function of detecting a URL (Uniform Resource Locator) designated in the received e-mail and linking a web identified by the detected URL. Thus, a user can readily input data into the service provider server 3-1.

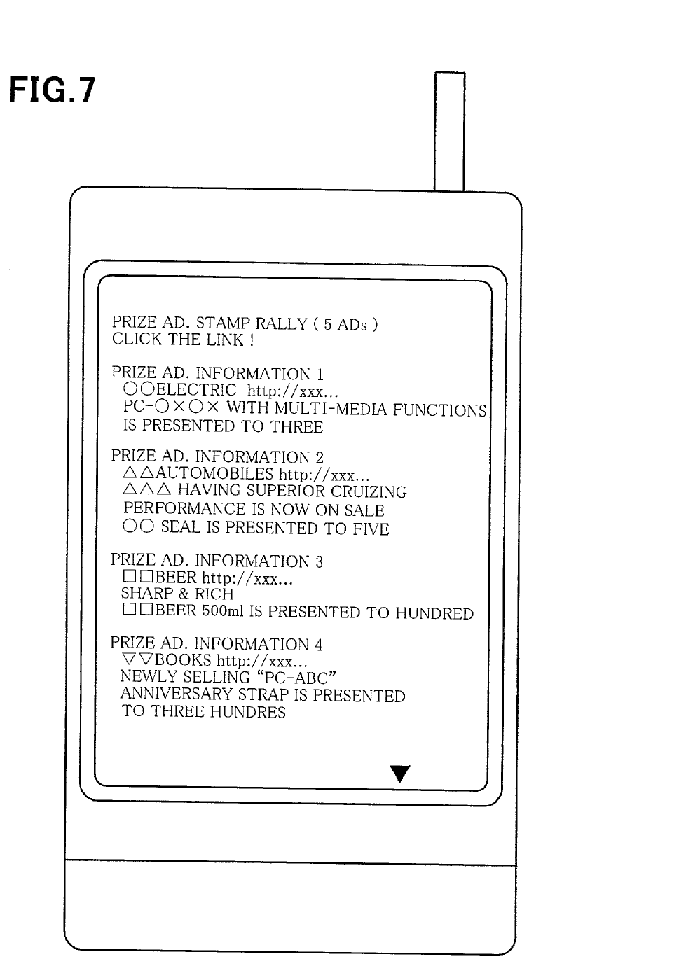

FIG. 7 illustrates a display screen of the user terminal 2-1 through which a user makes access to a prize advertisement stamp rally.

The service provider server 3-1 accepts application for a prize advertisement, based on the data necessary for application for a prize advertisement, input by a user in step A7. Then, the service provider server 3-1 transmits both the data input in step A7 and the user information input in step A5 to the prize advertisement presenter terminal 4-1 associated with the prize advertisement, as applicant data through the communication network 10, in step A8.

The service provider server 3-1 always monitors how many prize advertisements each of the users apply for. If the number of application for prize advertisements does not reach the predetermined number of prize advertisements listed in the prize advertisement list (NO in step A12), the service provider server 3-1 restarts the step A6. Until each of the users applies for prize advertisements by the predetermined number designated in the prize advertisement list, the steps A6, A7 and A8 are repeatedly carried out, in step A30.

On receipt of the applicant data from the service provider server 3-1, the prize advertisement presenter terminal 4-1 registers the user identified by the received applicant data, as an applicant who applies for the prize advertisement, in step A9.

Then, the prize advertisement presenter terminal 4-1 selects one applicant by drawing lots among the applicants when a certain period of time has passed, in step A10.

Then, the prize advertisement presenter terminal 4-1 prepares delivery of a prize to the selected user, in step A11.

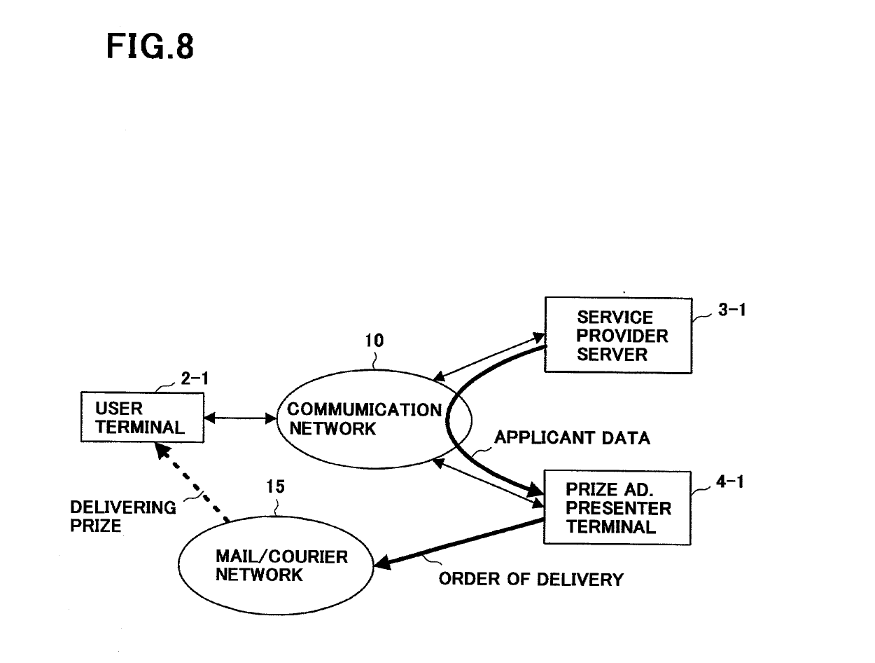

Then, a prize is delivered to the selected user from the prize advertisement presenter terminal 4-1 through the mail/courier network 15, as illustrated in FIG. 8.

If the number of application for prize advertisements reaches the predetermined number of prize advertisements listed in the prize advertisement list (YES in step A12), the service provider server 3-1 registers the user as an applicant who applied for prize advertisements by the predetermined number, and presents a privilege, for instance, a right to apply for a higher-grade prize competition, to the user.

Then, the service provider server 3-1 draws lots to thereby select one applicant among the above-mentioned applicants who applied for prize advertisements by the predetermined number, in step A13, and thereafter, orders the mail/courier network 15 to deliver a prize to the selected applicant, in step A14.

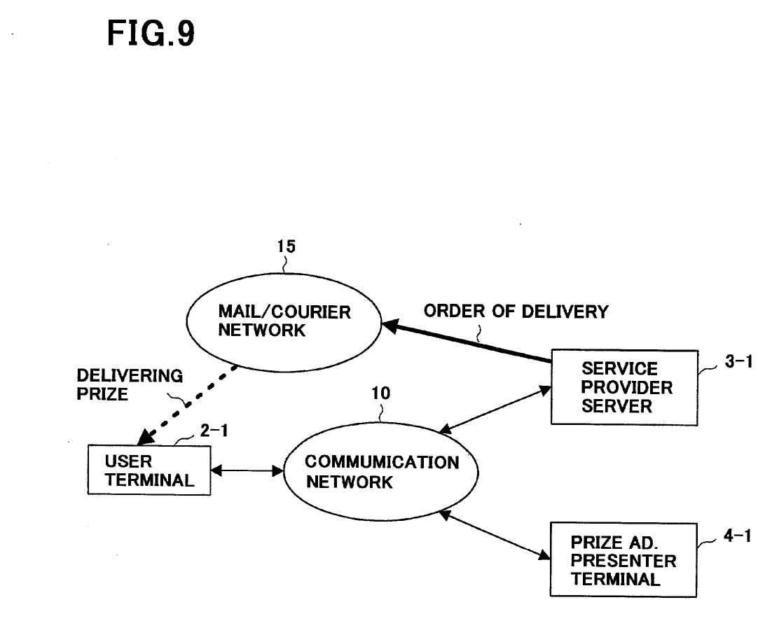

Then, a prize is delivered to the selected applicant through the mail/courier network 15, as illustrated in FIG. 9.

As having been explained so far, the service provider servers 3-1 to 3-M in the embodiment select prize advertisements matching to a user, among prize advertisements, based on user information of each of users registered in each of the service provider servers 3-1 to 3-M, and transmit a prize advertisement list including prize advertisement information about a plurality of prize advertisements selected as matching to a user, to the user terminals 2-1 to 2-N. Then, the service provider servers 3-1 to 3-M receive application of the user for a prize advertisement or prize advertisements listed in the prize advertisement list, and transmit the user information of users who apply for a prize advertisement or prize advertisements, to the associated prize advertisement presenter terminal 4-1 to 4-K as applicant data.

Thus, a prize advertisement presenter can effectively advertise to target users, and facilitate users to apply for prize advertisements, because each of users can readily apply for a plurality of prize advertisements, based on the prize advertisement list.

In addition, since the service provider servers 3-1 to 3-M transmit the user information having been registered therein, to the prize advertisement presenter terminals 4-1 to 4-K as applicant data, it is no longer necessary for a user to input the user information into the service provider servers 3-1 to 3-M each time he/she applies for a prize advertisement, ensuring reduction in workload of a user for applying for a prize advertisement. This facilitates a user to apply for prize advertisements much more.

Furthermore, a prize advertisement presenter can effectively collect user information of the target users, if only the prize advertisement presenter registers prize advertisement information to the service provider servers 3-1 to 3-M from his/her prize advertisement presenter terminal 4-1 to 4-K. Hence, in comparison with a case in which a prize advertisement presenter operates a server, he/she can significantly reduce workload and cost.

Furthermore, since the service provider servers 3-1 to 3-M may determine the number of prize advertisements to be presented in a prize advertisement list, in accordance with an application frequency designated in the user information, a service provider can provide prize advertisements to a user to a degree requested by the user.

In addition, since the service provider servers 3-1 to 3-M may monitor the number of application of the user for prize advertisements listed in a prize advertisement list, and present a privilege to the user, if the number of his/her application for prize advertisements reaches a predetermined number, it would be possible to facilitate users to apply for prize advertisements much more, and provide user information to a prize advertisement presenter much more.

Each of the user terminals 2-1 to 2-N may be comprised of any communication terminal, if it has a function of connecting to Internet. In particular, if a cellular phone is used by a user as the user terminals 2-1 to 2-N, as illustrated in FIGS. 2 and 7, a user could readily apply for prize advertisements without limitation of time or place, facilitating users to apply for prize advertisements.

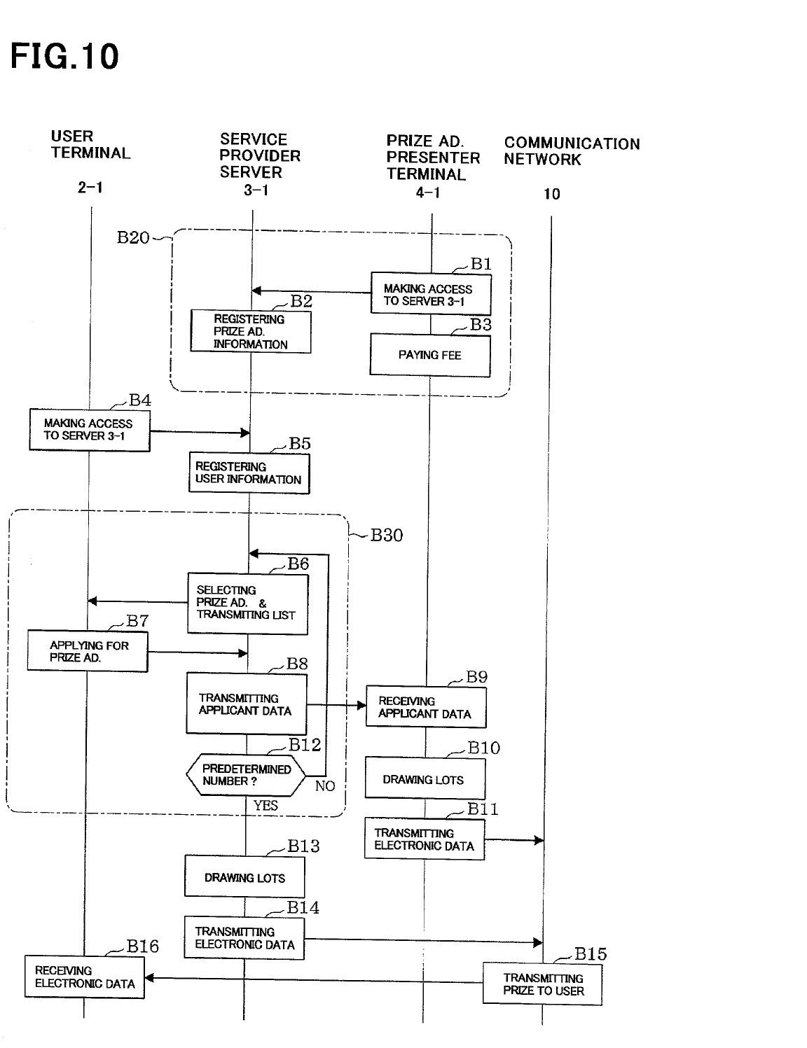

FIG. 10 is a sequence chart of a prize advertisement service system in accordance with the second embodiment. The prize advertisement service system in accordance with the second embodiment has the same structure as the structure of the advertisement service system in accordance with the first embodiment, illustrated in FIG. 1, but has operates in a different way from the first embodiment as follows.

Though a material was presented to a user as a prize in the first embodiment, an immaterial prize is presented to a user in the second embodiment. For instance, electronic data such as data defining a melody to be played when a user's cellular phone receives a call, a so-called “wall paper” which is displayed in a display screen of a cellular phone while the cellular phone is in a stand-by mode, or a program such as Java apret is presented to a user as a prize in the second embodiment.

In FIG. 10, steps B1 to B15 correspond to steps A1 to A15 shown in FIG. 3, and only steps B11 and B13 to B16 are different from the corresponding steps A11 and A13 to A16.

Subsequently to step B10 in which one applicant is selected by drawing lots, a prize comprised of electronic data is transmitted to the user terminal 2-1 from the prize advertisement presenter terminal 4-1 through the communication network 10, in steps B11 and B15.

Similarly, subsequently to step B13 in which one applicant is selected by drawing lots, a prize comprised of electronic data is transmitted to the user terminal 2-1 from the service provider server 3-1 through the communication network 10, in steps B14 and B15.

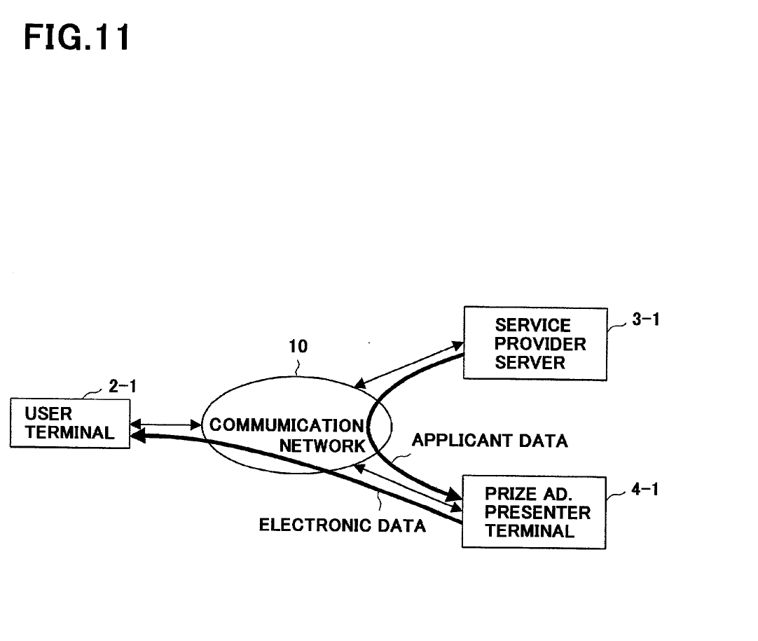

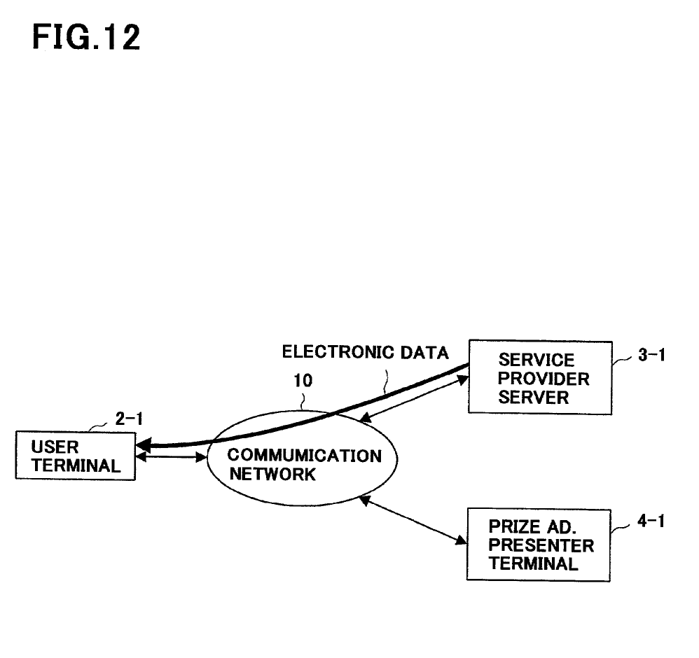

Thus, the user terminal 2-1 receives a prize comprised of electronic data, through the communication network 10, in step B16, as illustrated in FIGS. 11 and 12. FIG. 11 illustrates transmission of electronic data as a prize to the user terminal 2-1 from the prize advertisement presenter terminal 4-1, and FIG. 12 illustrates transmission of electronic data as a prize to the user terminal 2-1 from the service provider server 3-1.

As mentioned above, the prize advertisement presenter terminal 4-1 or the service provider server 3-1 transmits electronic data as a prize to the user terminal 2-1 of the selected user through the communication network 10 in the second embodiment. As a result, it is no longer necessary for the prize advertisement service system in accordance with the second embodiment to have the mail/courier network 15 unlike the first embodiment, ensuring significant reduction in costs necessary for conducting prize advertisements.

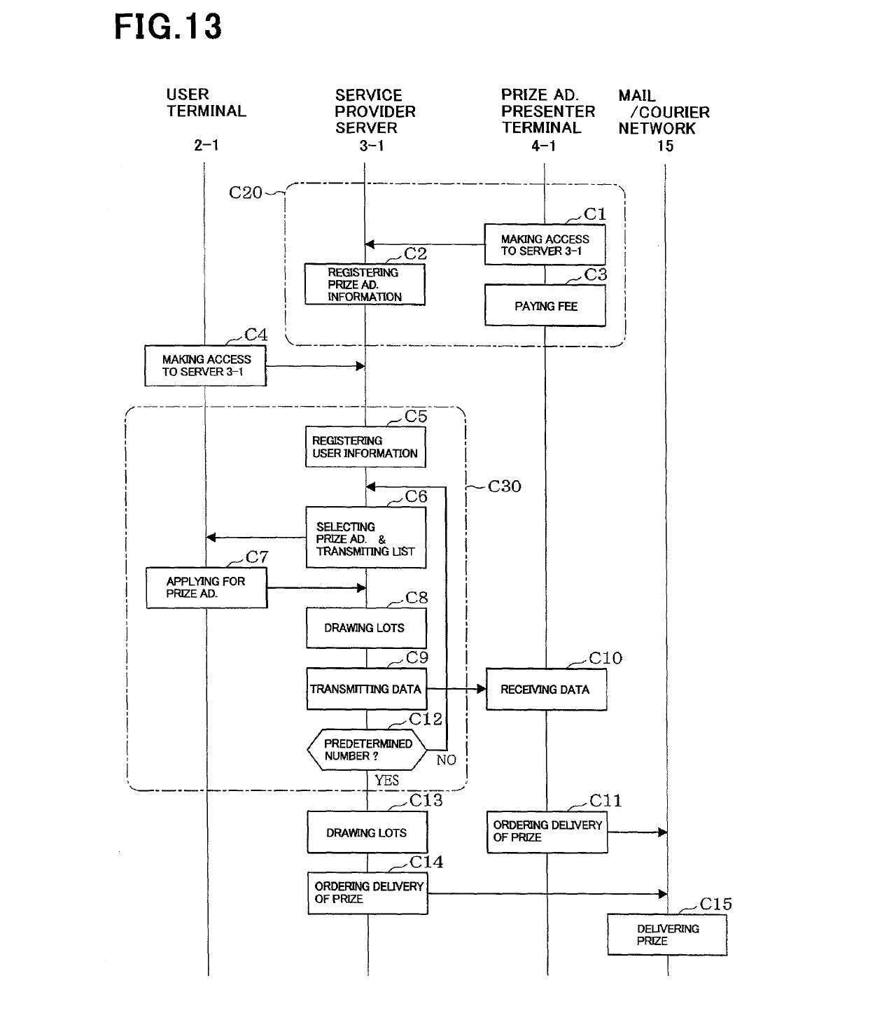

FIG. 13 is a sequence chart of a prize advertisement service system in accordance with the third embodiment. The prize advertisement service system in accordance with the third embodiment has the same structure as the structure of the advertisement service system in accordance with the first embodiment, illustrated in FIG. 1, but has operates in a different way from the first embodiment as follows.

In the first embodiment, a prize advertisement presenter selects one or more applicant(s) to which a prize is to be presented, by drawing lots. In the third embodiment, a service provider selects one or more applicant(s) to which a prize is to be presented, by drawing lots, on behalf of a prize advertisement presenter.

In FIG. 13, steps C1 to C7 and C11 to C15 correspond to the steps A1 to A7 and A11 to A15 illustrated in FIG. 3.

The prize advertisement service system in accordance with the third embodiment may be combined with the prize advertisement service system in accordance with the second embodiment. That is, electronic data may be presented as a prize to a user also in the later-mentioned third embodiment.

On receipt of application of a user for a prize advertisement in step C7, the service provider server 31 makes a database of applicants, and selects one or more applicant(s) to whom a prize is to be presented, by drawing lots in each of prize advertisements, in step C8.

Then, the service provider server 31 transmits applicant data and selected applicant data to the prize advertisement presenter terminal 41, in step C9. On receipt of the applicant data and selected applicant data in step C10, the prize advertisement presenter orders the mail/courier network 15 to deliver a prize to the selected applicant, based on the received applicant data and selected applicant data, in step C11.

In accordance with the third embodiment, since the service provider server 31 selects one or more applicant(s) to whom a prize is to be presented, by drawing lots in each of prize advertisements, it would be possible for a prize advertisement presenter to significantly reduce workload.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2001-009738 filed on Jan. 18, 2001 including specification, claims, drawings and summary is incorporated herein by reference in its entirety.

What is claimed is:

1. A prize advertisement service system where a desired advertisement is conducted by conducting a prize advertisement is conducted on a communication network, and data about applicants who apply for said prize advertisement is collected, comprising:
(a) a first terminal of a prize advertisement presenter who presents a prize advertisement;
(b) a second terminal of a user who applies for said prize advertisement; and
(c) a server of a service provider which connects said first and second terminals to each other through a communication network,
said server including functions of:
(c1) registering prize advertisements into said server in accordance with prize advertisement information received from said first terminal;
(c2) registering a user who wants to apply for said prize advertisements, in accordance with user information received from said second terminal;
(c3) selecting one or more prize advertisement(s) which matches to said user, among the registered prize advertisements, in accordance with said user information;
(c4) transmitting data indicative of a list of the selected prize advertisement(s), to said second terminal;
(c5) receiving an application of said user for one or more prize advertisements among the listed prize advertisement(s), from said second terminal; and
(c6) transmitting the user information of said user having applied for said prize advertisements, to said first terminal as applicant data indicative of an applicant or applicants applying for said prize advertisement(s).

2. The prize advertisement service system as set forth in claim 1, wherein said server determines the number of prize advertisements listed in said list, in accordance with an application frequency predetermined in said user information, when said server selects said one or more prize advertisement(s).

3. The prize advertisement service system as set forth in claim 1, wherein said server further has a function of administrating the number of applications of a user for said prize advertisement(s) listed in said list, and deciding presenting a special award to a user who applied for said prize advertisement(s) by the predetermined number.

4. The prize advertisement service system as set forth in claim 1, wherein said first terminal has a function of selecting one or more applicant(s) among the applicants identified by said applicant data transmitted from said server, for presenting a prize identified in said prize advertisement(s) thereto, by drawing lots.

5. The prize advertisement service system as set forth in claim 4, wherein said first terminal further has a function of managing delivery of a prize presented in said prize advertisement(s), to the selected user(s), based on the result of said lots.

6. The prize advertisement service system as set forth in claim 3, wherein said server further has a function of drawing lots for selecting one or more user(s) among the users to which said special award was presented.

7. The prize advertisement service system as set forth in claim 6, wherein said server further has a function of managing delivery of a prize to the selected user(s), based on the result of said lots.

8. The prize advertisement service system as set forth in claim 6, wherein said server further has functions of:
selecting one or more applicant(s) among the applicants of said prize advertisement(s), for presenting a prize identified in said prize advertisement(s) thereto, by drawing lots; and
transmitting data indicative of the selected applicant(s) to said first terminal as prize-winner data.

9. The prize advertisement service system as set forth in claim 8, wherein said first terminal has a function of managing delivery of a prize to said selected applicant(s), based on said prize-winner data transmitted from said server.

10. The prize advertisement service system as set forth in claim 5, wherein said prize transmitted from said first terminal to said second terminal of said selected applicant(s) is comprised of electronic data.

11. The prize advertisement service system as set forth in claim 7, wherein said prize transmitted from said server to said second terminal of said selected applicant(s) is comprised of electronic data.

12. The prize advertisement service system as set forth in claim 9, wherein said prize transmitted from said first terminal to said second terminal of said selected applicant(s) is comprised of electronic data.

13. The prize advertisement service system as set forth in claim 1, wherein said second terminal is comprised of a cellular phone.

14. A method of conducting a prize advertisement in a prize advertisement service system for conducting a desired advertisement and collecting data about applicants who apply for said prize advertisement,
said prize advertisement service system including:
a first terminal of a prize advertisement presenter who presents a prize advertisement;
a second terminal of a user who applies for said prize advertisement; and
a server of a service provider which connects said first and second terminals to each other through a communication network,
said method comprising the steps of:
(a) registering prize advertisements into said server in accordance with prize advertisement information received from said first terminal;
(b) registering a user who wants to apply for said prize advertisements, in accordance with user information received from said second terminal;
(c) selecting one or more prize advertisement(s) which matches to said user, among the registered prize advertisements, in accordance with said user information;
(d) transmitting data indicative of a list of the selected prize advertisement(s), to said second terminal;
(e) receiving an application of said user for one or more prize advertisements among the listed prize advertisement(s), from said second terminal; and
(f) transmitting the user information of said user having applied for said prize advertisements, to said first terminal as applicant data indicative of an applicant or applicants applying for said prize advertisement(s), said steps (a) to (f) being to be carried out by said server.

15. The method as set forth in claim 14, further comprising the step of (g) determining the number of prize advertisements listed in said list, in accordance with an application frequency predetermined in said user information, in said step (c),
said step (g) being to be carried out by said server.

16. The method as set forth in claim 14, further comprising the step of (h) administrating the number of applications of a user for said prize advertisement(s) listed in said list, and deciding presenting a special award to a user who applied for said prize advertisement(s) by the predetermined number,
said step (h) being to be carried out by said server.

17. The method as set forth in claim 14, further comprising the step of (i) selecting one or more applicant(s) among the applicants identified by said applicant data transmitted from said server, for presenting a prize identified in said prize advertisement(s) thereto, by drawing lots,
said step (i) being to be carried out by said first terminal.

18. The method as set forth in claim 17, further comprising the step of (j) managing delivery of a prize presented in said prize advertisement(s), to the selected user(s), based on the result of said lots,
said step (j) being to be carried out by said first terminal.

19. The method as set forth in claim 16, further comprising the step of (k) drawing lots for selecting one or more user(s) among the users to which said special award was presented,
said step (k) being to be carried out by said server.

20. The method as set forth in claim 19, further comprising the step of (l) managing delivery of a prize to the selected user(s), based on the result of said lots,
said step (1) being to be carried out by said server.

21. The method as set forth in claim 18, further comprising the steps of:
(m) selecting one or more applicant(s) among the applicants of said prize advertisement(s), for presenting a prize identified in said prize advertisement(s) thereto, by drawing lots; and
(n) transmitting data indicative of the selected applicant(s) to said first terminal as prize-winner data,
said steps (m) and (n) being to be carried out by said server.

22. The method as set forth in claim 21, further comprising the step of (o) managing delivery of a prize to said selected applicant(s), based on said prize-winner data transmitted from said server,
said step (o) being to be carried out by said first terminal.

23. The method as set forth in claim 18, wherein said first terminal transmits electronic data to said second terminal of said selected applicant(s) as said prize in said step (j).

24. The method as set forth in claim 20, wherein said server transmits electronic data to said selected user(s) as said prize in said step (l).

25. The method as set forth in claim 22, wherein said first terminal transmits electronic data to said second terminal of said selected applicant(s) as said prize in said step (o).

26. A server to be used in a prize advertisement service system where a desired advertisement is conducted by conducting a prize advertisement is conducted on a communication network, and data about applicants who apply for said prize advertisement is collected,
said server being owned by a service provider, and constituting said prize advertisement service system together with (a) a first terminal of a prize advertisement presenter who presents a prize advertisement, and (b) a second terminal of a user who applies for said prize advertisement, said server connecting said first and second terminals to each other through a communication network,
said server including functions of:
(c1) registering prize advertisements into said server in accordance with prize advertisement information received from said first terminal;
(c2) registering a user who wants to apply for said prize advertisements, in accordance with user information received from said second terminal;
(c3) selecting one or more prize advertisement(s) which matches to said user, among the registered prize advertisements, in accordance with said user information;
(c4) transmitting data indicative of a list of the selected prize advertisement(s), to said second terminal;
(c5) receiving an application of said user for one or more prize advertisements among the listed prize advertisement(s), from said second terminal; and
(c6) transmitting the user information of said user having applied for said pri1ze advertisements, to said first terminal as applicant data indicative of an applicant or applicants applying for said prize advertisement(s).

27. The server as set forth in claim 26, further including a function of determining the number of prize advertisements listed in said list, in accordance with an application frequency predetermined in said user information, when said server selects said one or more prize advertisement(s).

28. The server as set forth in claim 26, further including functions of administrating the number of applications of a user for said prize advertisement(s) listed in said list, and deciding presenting a special award to a user who applied for said prize advertisement(s) by the predetermined number.

29. The server as set forth in claim 28, further including a function of drawing lots for selecting one or more user(s) among the users to which said special award was presented.

30. The server as set forth in claim 29, further including a function of managing delivery of a prize to the selected user(s), based on the result of said lots.

31. The server as set forth in claim 29, further including functions of:
selecting one or more applicant(s) among the applicants of said prize advertisement(s), for presenting a prize identified in said prize advertisement(s) thereto, by drawing lots; and
transmitting data indicative of the selected applicant(s) to said first terminal as prize-winner data.

32. The server as set forth in claim 30, wherein said prize transmitted from said server to said second terminal of said selected applicant(s) is comprised of electronic data.
